(19) United States
(12) Patent Application Publication
(10) Pub. No.: US 2011/0029610 A1
(43) Pub. Date: Feb. 3, 2011

(54) Content Sharing in Mobile Devices

(76) Inventors: Shen-Chang Chao, Hong Kong (HK); Edward Lor, Hong Kong (HK); King Wai Chow, Hong Kong (HK); Vincent Chung Wai Wong, Hong Kong (HK); Karen Ka Yee Leung, Hong Kong (HK)

Correspondence Address: WELLS ST. JOHN P.S., 601 W. FIRST AVENUE, SUITE 1300, SPOKANE, WA, 99201, US

(21) Appl. No.: 12/533,991

(22) Filed: Jul. 31, 2009

(51) Int. Cl. G06F 15/16

(52) U.S. Cl. 709/204

(57) ABSTRACT

Sharing content via a mobile device includes creating a first list of content available for sharing and storing the list in a mobile device, creating a second list of contacts having content sharing permissions and storing the second list in the mobile device, and sharing the first list with a contact in the second list via a wireless network. Sharing the first list with a contact in the second list via a wireless network does not include the use of an intermediary content sharing server.

### BACKGROUND TO THE INVENTION

1. Field of the Invention

The current invention relates to social networking via a mobile device and more particularly to a content sharing via a mobile device.

2. Background Information

The so-called web 2 phenomenon has sparked an increase in demand for information sharing and collaboration between individuals. The internet has become an integral part of everyday life with many people now being members of some form of web based service, web forum or on-line community which allows them to interact with others. On the back of this people have developed a need and desire to share information, pictures, video, comments and other electronic based content with others on an everyday basis. A user may have contents spread across several different social networking sites, such as FaceBook, Flickr, Picassa, network capable mobile phone (Smartphone) or other mobile device, a home PC, IP-television top set box internet enabled personal video recorder. Increasingly, users want to share or market their sharable content anywhere and anytime.

### SUMMARY OF THE INVENTION

The current invention provides a method for facilitating content sharing via a mobile device. The method includes, but is not limited to creating a first list of content available for sharing and storing the list in a mobile device. Creating a second list of contacts having content sharing permissions and storing the second list in the mobile device. And, sharing the first list with a contact in the second list via a wireless network. The contacts in the second list are associated with content available for sharing in the first list.

Sharing the first list with a contact in the second list via a wireless network does not include the use of an intermediary content sharing server.

Functions of creating the first and second lists and sharing the first list with a contact in the second list are provided by software applications or application modules. At least one of the modules is stored in memory of the mobile device and is executable by a processor of the mobile device.

Further aspects of the invention will become apparent from the following description, which is given by way of example only.

### BRIEF DESCRIPTION OF THE DRAWINGS

An exemplary form of the present invention will now be described by way of example only and with reference to the accompanying drawings, in which:

FIG. 1 is a schematic illustration of a mobile device on which the current invention may be implemented,

FIG. 2 is a root level illustration of a virtual directory of sharable contact according to the invention,

FIG. 3 is a folder level illustration of the virtual directory of sharable contact according to the invention, and

FIG. 4 is a schematic flow diagram of contact list generation for content sharing according to the invention.

### DESCRIPTION OF THE EXEMPLARY EMBODIMENTS

Before any embodiments of the invention are explained in detail, it is to be understood that the invention is not limited in its application to the details or arrangements set forth in the following description or illustrated in the drawings. The invention is capable of other embodiments and of being practiced or of being carried out in various ways. Also, it is to be understood that the phraseology and terminology used is for the purpose of description only and should not be regarded as limiting.

One or more of the inventors has already proposed a device and method for participating in a peer-to-peer network is application Ser. No. 12/059,787 filed on 31 Mar. 2008 and a method and device for providing offline web services filed as U.S. application Ser. No. 12/335,215 on 15 Dec. 2008. The entire contents of both of said applications Ser. Nos. 12/059,787 and 12/335,215 are incorporated herein by reference. These two applications provide for a device and method for forming offline peer-to-peer networks and for content sharing between two or more devices belong to the same user located in different locations. These other methods and devices are complementary to the current invention and, although not critical to the current invention, may be implemented together with the current invention in a single mobile device.

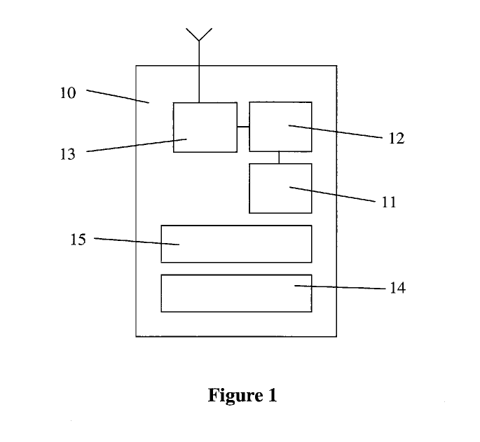

The invention provides a method of content sharing via a mobile device such as a Smartphone, PDA, netbook or laptop-type device without the need for or use of a third party content sharing or social networking site server. In the preferred embodiment the invention uses a Smartphone like that schematically illustrated in FIG. 1. The Smartphone 10 has a memory 11, a processor 12, a wireless radio module 13 and user interface means in the form of a keypad 14 and screen 15.

In a preferred embodiment of the invention a user creates and stores on their mobile device an aggregated list of all sharable content. The content may be spread across several different social networking sites, such as FaceBook, Flickr, Picassa, or in a network capable mobile phone (Smartphone) or other mobile device, a home PC, IP-television top set box internet enabled personal video recorder. The list could be in the form of a simple text file or other list structures know in the art. The list can be created by manual entry by the user or by a search program. The search program operates, for example, by allowing the user to select one or more search locations and one or more file types, searching those locations for the file types and then presenting the user with search results from which the user can select content to add to the list of sharable content.

In the preferred embodiment the list of sharable content is in the form of a virtual directory in which sharable content can be grouped and organized. The virtual directory contains two types of items, namely folder items and sharable content items. Folders provide means for grouping and organizing content items and may contain other folders or content items themselves. Content items have various types to describe what type of content they are. Such types can be internet shortcuts, audio tracks, video clips, photographs, documents. The type of sharable content is almost endless. Content items in the list or virtual directory are in fact a virtual item and not the content itself. The content item provides a link to the actual content which may be stored on the mobile device itself or in another location, such as the internet, a user's page on a social networking site, another mobile device or a computer in a different location, or an internet enabled personal video recorder or set top box. A user browsing the virtual directory is able to see the name and type of content from the listed content items contained either in the root directory or in folders. By clicking on a content item the browsing user is able to get the content, if stored locally, or details of where the content can be found/accessed or a link (shortcut) directly to the content on another device.

The mobile device containing the list, or virtual directory, of a user's content becomes a content management device that enables a user to publish or advertise their content without the need for a centralized server such as those provided by social networking and content sharing sites. The user can publish or advertise their content by sending the virtual directory to other users in peer-to-peer networks or via the internet for an internet connected Smartphone for example, or by making the list available to other users who may connect to the mobile device containing the list.

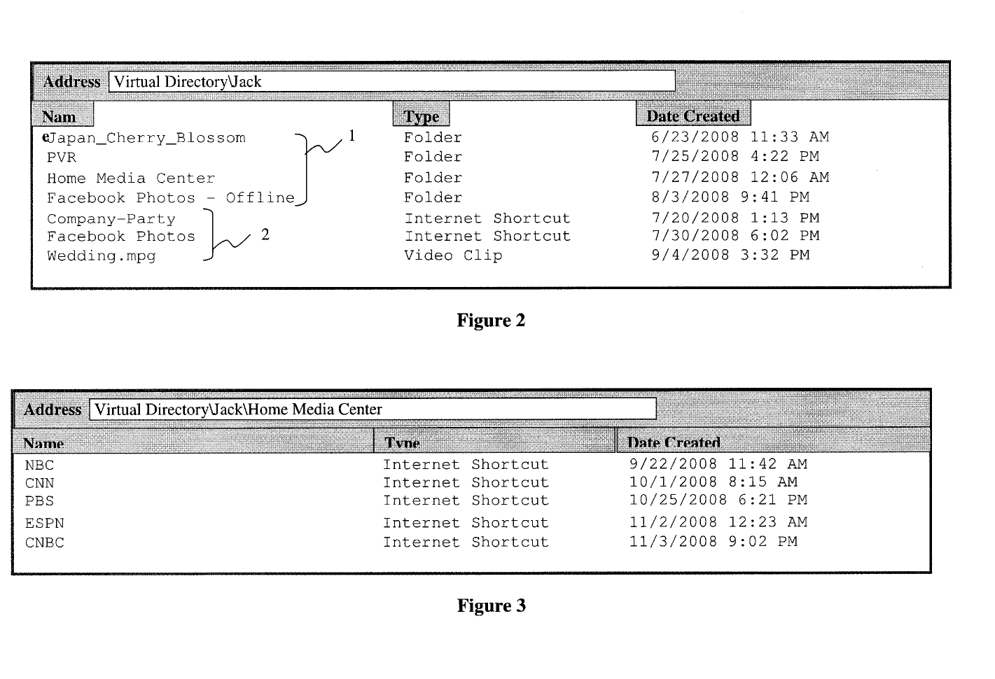

FIGS. 2 and 3 illustrate an example of a virtual directory list of content according to the invention. FIG. 2 illustrates the root of the virtual directory content list for user Jack having folder items 1 and content items 2. The directory contains a name, a column for item type and column for date created as is typical for electronic-type directories. FIG. 3 illustrates the content within a folder item named “Home Media Centre” showing further content items 2.

Generally, a user will not want to make all of his or her sharable content public or available to everyone. In one embodiment of the invention each content item in the list also has a sharing property that indicates a user, users, class of user or device that may have access to the content item and associated content that it represents. The mobile device also contains a contact or friends list having details of other people or devices with which the mobile device can share the content sharing list. Such contacts can be imported from content/friend lists in other devices, applications or on-line communities such as mobile devices, PCs, Yahoo, Google, MSN, FaceBook friends, linkedin. Such imported contacts can be organized into groups with different content sharing/viewing rights which correspond to sharing properties of content items. In this way a user can control which contacts/friends can view and access certain content. Users are accessing or viewing a virtual directory content list only have access to those content items and folders authorized by their group or contact association. The contacts/friends list leverages off existing contacts lists of a user on social networking sites. In one embodiments of the invention existing privileges and/or sharing rights from the social networking site are imported into the content sharing and contacts/friends lists. For example, on a social networking site a user may belong to a “work” group of work colleagues. That group membership is imported into the contacts/friends list and members have access to content whose sharing property includes members of the “work” group.

In addition to permanent contact lists a user or mobile device may wish to form a permanent or adhoc content sharing group or community during certain events. For example, if a user is at a party or social gathering with other mobile device users who form a peer-to-peer network may form adhoc contact groups in order to share content via the virtual directory content list with other users in the peer-to-peer network.

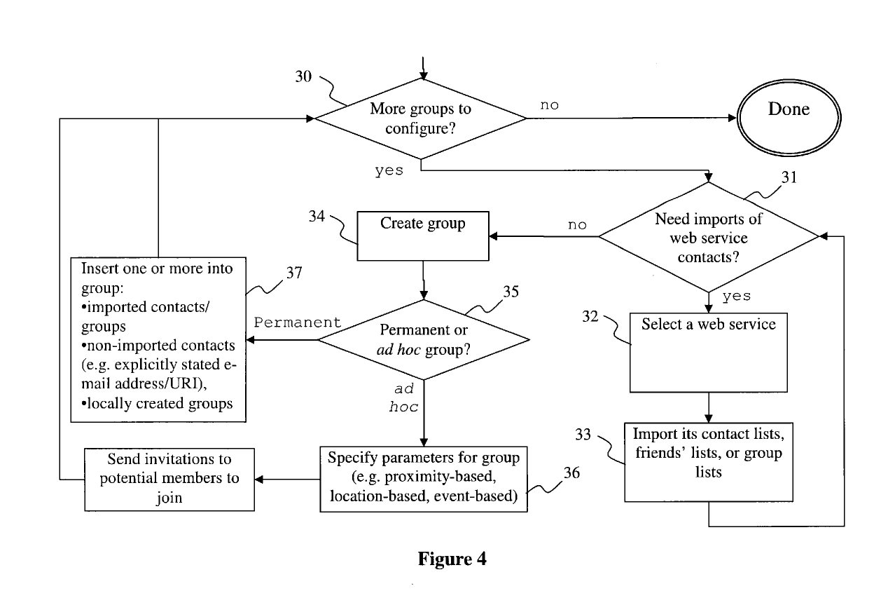

FIG. 4 illustrates steps in a method for setting up a permanent group of contacts/friends according to one embodiment of the invention. In decision block 30 a decision is made whether there are more groups to configure. If there are none then the method ends. If there are more groups to configure then a loop begins at decision block 31 comprising a process block 32 of selecting a web service and process block 33 of importing the content list, friend list and group list from the web service into the mobile device group contacts. The loop continues until there is no need to import any more web service contacts as decided in decision block 31. The method moves to a group creation block 34 and where a contact group is created based on the imported contacts/friend lists. A decision is made in block 35 as to whether the group is permanent or an adhoc group. A permanent group is kept permanently within the mobile device. An adhoc groups is temporary and only for the current content sharing session. If the group is an adhoc group then parameters for ending/deleting the group are established at block 36. Such parameters specify whether the adhoc group is proximity or location based which might be determined on connection to a particular wireless network or a peer-to-peer contacts. An adhoc group can also be event based such as only during a social gathering. In adhoc groups invitations can be sent to additional members to join the group such as users of a peer-to-peer network. If the group is a permanent group then parameters such as memberships of the group and content sharing permissions are defined.

It will be evident to skilled addressees that the invention can be implemented using a third party application or software module which can be installed in the device memory and run by the processor of the mobile device. Development of third party applications for mobile devices is commonplace and the development of such applications for implementation of the invention will be readily apparent and pose no difficulty to one of ordinary skilled in the art. However, this is not intended to limit the scope or functionality of the invention and it is envisaged that the invention may be implement thought firmware built directly into a mobile device by the device vendor. Additionally, some aspects such as searching and creating a list of sharable content and/or creating or importing lists of contacts may be implemented by software applications running on a more powerful personal computer (PC) and the lists transferred to the mobile device memory via known means such as USB interface.

In use, a user of the mobile device, such as a smart phone, connects to a wireless network using one or more means such as Wi-Fi, cellular (e.g. 3G), Bluetooth, HSDPDA and the like. The user of the device has already created the virtual directory list of sharable content. The content may reside either on the mobile device itself or on other devices elsewhere that are accessible via an internet connection, as well as a contact list of contacts/friends with which content may be shared. During the wireless network session the user may pair their mobile device with others devices including that of a second user who is in their contact list. The second user may wish to browse content that the first user has available for sharing. The second user can request a copy of the virtual directory list of the first user. After authentication the list is transmitted via the wireless network to the second user's device for viewing. If the second user wishes to view any content shown in the list, the list provides details of where the content can be located. It can be requested from the first mobile device if located in that device or from a device elsewhere via the internet.

What is claimed is:

1. A method for facilitating content sharing via a mobile device comprising:
providing a first application module for creating a first list of content available for sharing and storing the list in a mobile device,
providing a second application module for creating a second list of contacts having content sharing permissions and storing the second list in the mobile device, wherein contacts in the second list are associated with content available for sharing in the first list, and
providing a third application module for sharing the first list with a contact in the second list via a wireless network.

2. The method of claim 1 wherein at least one of the first application module, second application module or third application module is provided in a memory of a mobile device having a wireless radio module and is executable by a processor of the mobile device.

3. The method of claim 1 wherein sharing the first list with a contact in the second list via a wireless network does not include the use of an intermediary content sharing server.

4. The method of claim 1 wherein the first application facilitates populating the first list with folder items and content items, and wherein a folder item can contain a content item or another folder item.

5. The method of claim 4 wherein a content item identifies content stored in the mobile device or elsewhere.

6. The method of claim 1 wherein the second application facilitates importing into the second list one or more contacts from a contact list stored elsewhere.

7. The method of claim 6 wherein importing into the second list one or more contacts from a contact list or friend relationships plus content sharing permissions stored elsewhere includes importing information defining how contacts in the second list are associated with content available for sharing in the first list.

8. The method of claim 1 wherein the second application facilitates adding to the second list one or more contacts based on membership of a peer group network to which the mobile device is connected.

9. The method of claim 1 wherein sharing the first list with a contact in the second list comprising authenticating the contact.

10. The method of claim 1 wherein sharing the first list with a contact in the second list comprises transmitting at least a part of the first list via a wireless network.

11. A mobile device for facilitating content sharing comprising:
a processor,
a memory readable by the processor,
a first list of content available for sharing, the first list stored in the memory,
a second list of contacts having content sharing permissions, the second list stored in the memory, and
an application stored in the memory, the application executable by the processor for sharing the first list with a contact in the second list via a wireless network.

12. The mobile device of claim 11 wherein the first list comprises folder items and content items, and wherein a folder item can contain a content item or another folder item.

13. The mobile device of claim 2 wherein a content item identifies content stored in the mobile device or elsewhere.
